(19) United States
(12) Patent Application Publication
(10) Pub. No.: US 2010/0289701 A1
(43) Pub. Date: Nov. 18, 2010

(54) ANTENNA CONFIGURED FOR BANDWIDTH IMPROVEMENT ON A SMALL SUBSTRATE.

(75) Inventors: Gerald Reuben DeJean, Redmond, WA (US); Sean R. Mercer, Issaquah, WA (US); Vasco Rubio, Edmonds, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/466,388

(22) Filed: May 15, 2009

(51) Int. Cl. H01Q 1/38

(52) U.S. Cl. 343/700 MS

(57) ABSTRACT

Described is an antenna having a patch with slits configured to meet specified frequency and bandwidth requirements. For example, for a dual-polarized antenna with two feedlines, the patch has three slits that are configured to determine the antenna's frequency characteristics; the patch has no (or a substantially reduced) fourth slit, thereby providing wider bandwidth. The slits may be sized to provide the desired frequency characteristics. Also described is having the equivalent of variable slits via electronic or mechanical configuration. For diagonal feedlines, the slits may be symmetrically arranged, e.g., one horizontal slit extending from one side of the patch and two vertical slits extending from the upper and lower edges of the patch. The antenna may be used in a device such as a gaming console.

### BACKGROUND

Contemporary consumers want small, reasonably portable electronic devices. At the same time, such devices are becoming more and more multifunctional, providing many features. As a result, numerous component parts need to be put into the device and integrated together. Thus, as the size of such devices shrink, the components need to be smaller.

By way of example, contemporary gaming consoles not only provide gaming functionality, but also provide networking experiences, such as internet competition, movie streaming and so forth. At the same time, such gaming consoles include wireless communication links for controller-to-console communications, and internet communications (although a wired connection may be used).

An antenna is thus needed to provide reliable communication links (e.g., via Bluetooth®, Wi-Fi and/or proprietary wireless links) between such a console or other devices and the peripheral devices with which it communicates. In general, a patch antenna is used in such devices, in which the physical position of the patch antenna is fixed in the device.

As the device form factor gets smaller, the size of the patch antenna also needs to be smaller to meet the physical design specifications. However, when attempting to shrink the size of the antenna, the bandwidth needed to meet the specified frequency range becomes too small using existing antenna designs. Desired results can likely be obtained by using relatively expensive dielectric materials for the antenna substrate; however the expense of such materials is unacceptable for products that are to be mass produced.

In sum, existing antenna technology is unable to deliver the desired bandwidth and cost targets for physically small and fixed patches as specified by small product form factors. Any technology that can achieve the desired bandwidth with acceptable cost is thus valuable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a patch antenna meets specified frequency and bandwidth requirements via slits on a patch element of the antenna. For example, for a dual-polarized antenna having two feedlines, the patch has three slits that are configured to determine the antenna's frequency characteristics, and no (or a substantially reduced) fourth slit, which by its elimination (or reduction) provides wider bandwidth.

The slits may be physically configured to provide the desired frequency characteristics, e.g., via their size (width and/or height dimensions). Alternatively, the slits may be electronically configured and/or mechanically configured.

In one implementation, the patch is coupled to feedlines, such as via aperture coupling through slots in a ground plane; the ground plane is on the opposite side of a substrate that supports the feedlines, e.g., on its underside. For diagonal feedlines, with respect to the x and y directions, one of the three frequency slits extends substantially horizontally, and the other two extend substantially vertically, that is, one extends upward and one extends downward from an respective lower and upper edge of the patch.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of an antenna structure in outline form.

FIG. 2 is a representation of the antenna in a stacked-up configuration showing elements from the patch (the highest in the z-direction) to the feedlines (the lowest in the z-direction).

FIG. 3 is a representation of how a patch antenna may be positioned in a gaming console or other device.

FIGS. 4 and 5 are representations of the antenna showing alternate substrate configurations that can be used for the inclusion of spacers.

FIG. 6 is a representation of a patch demonstrating surface current directions of the patch excited along the diagonals from the bottom left to the top right.

FIG. 7 is a graph illustrating return loss versus frequency of four-slit and three-slit patch designs.

FIG. 8 is a representation of a patch having two slits for linear feeds.

FIG. 9 is a representation of a patch having slots instead of slits for openings.

FIG. 10 is a representation of a patch having slits arranged diagonally with respect to the patch surface.

FIG. 11 is a representation of a patch having three slits that provide desired frequency characteristics and one substantially reduced-size slit that provides desired bandwidth characteristics.

FIG. 12 is a representation of a patch having slits having effective dimensions that are configurable by a controller.

### DETAILED DESCRIPTION

Various aspects of the technology described herein are generally directed towards a patch antenna with slits that are configured to provide desired frequency and/or bandwidth characteristics. In one implementation, for a dual-polarized design, three slits (“frequency slits”) in the patch provide the desired frequency, while the conventional fourth slit (a “bandwidth slit”) is reduced in size (including eliminating the fourth slit altogether by having it reduced to zero size) for impedance bandwidth enhancement on small size substrates. Note that heretofore, four slits in the patch have been used, however as described herein, eliminating (or reducing the size of) one of the slits increases the impedance bandwidth of the antenna.

While a gaming console is exemplified herein as one device that benefits from such an antenna/antenna system, it should be understood that this is only one practical example usage. Other uses for such an antenna are straightforward to implement, such as in personal computers, wireless access points/routers, printers, remote controlled appliances, and virtually any type of device that uses or may benefit from wireless communications. Further, the type of wireless communication can be at any suitable frequency using any wireless technology (e.g., Bluetooth®, Wi-Fi or proprietary technologies).

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in antenna technology and wireless communication technology in general.

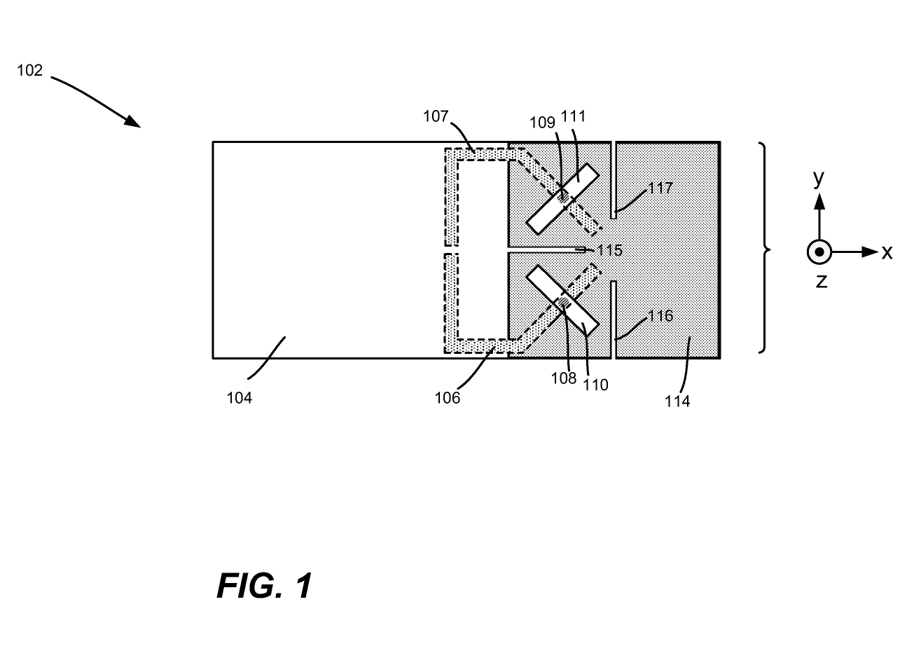

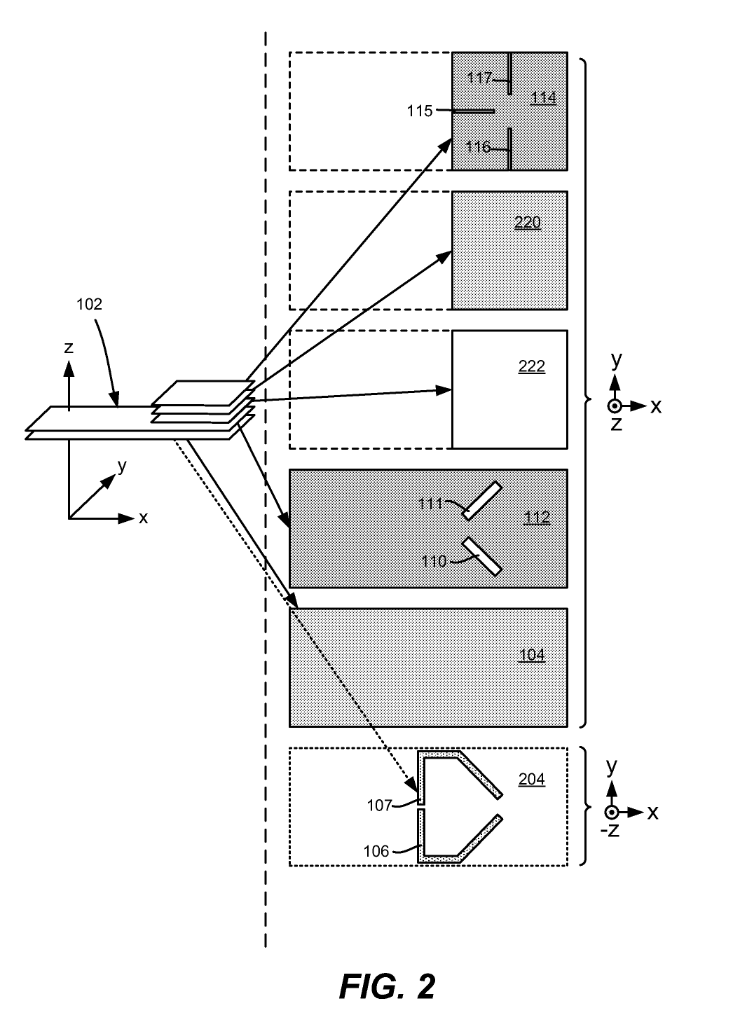

FIGS. 1 and 2 show various aspects of one example implementation of an antenna 102 having a number of layered elements. In these figures, a stacked arrangement is shown, however as described below, various alternatives may be used to combine the elements into the antenna.

Returning to FIGS. 1 and 2, one layer of the antenna 102 comprises a bottom substrate 104, which includes (e.g., on its bottom surface) two feedlines 106 and 107 that provide feed points 108 and 109 respectively via slots 110 and 111 in a ground plane 112 (FIG. 2). As described below, the slots 110 and 111 that exist in the ground plane 112 facilitate aperture coupling from the feedlines 106 and 107 to a radiating patch 114 over a top substrate 220 (FIG. 2). The shape or size of the overall antenna ground structure indicated by 102 can vary widely in different antenna designs. The geometry of the ground plane is one factor that influences antenna gain. In alternative implementations, other ways of providing the feeds may be used, e.g., via coaxial conductors.

Note that the dashed boxes associated with elements 114 and 220 are provided to show an approximate positioning and size relationship with the other antenna elements in one implementation. However, the illustrated relative sizes are only example approximations for one implementation, and are not necessarily to scale.

As is known in dual-polarized designs, one of the feedlines is selected depending on current conditions (generally corresponding to the current orientation of the peripheral device's antenna). With respect to the slots, feedlines and feed points, because the ground plane 112 will likely be loaded with other RF/digital components, the feedlines 106 and 107 are positioned underneath. Aperture coupling via the slots 110 and 111 is employed such that energy from an actively selected feedline (e.g., 106) couples at the respective feed point (e.g., 108) through the respective aperture (one of the slots, e.g., 110) in the ground plane 112 to the patch 114 for excitation. Maintaining symmetry for dual-polarized designs allows the antenna performance to be nearly the same for either feed.

The radiating patch 114 is layered on a top substrate 220 as shown in FIG. 2. The patch 114 includes three slits 115-117 symmetrically arranged relative to the feed points 108 and 109, with one slit 115 extending in the direction of the x-axis and two slits 116 and 117 extending in the direction of the y-axis in FIG. 1. In other words, the slit 115 is symmetrically placed in between the position of the two feedlines 106 and 107, while each of the other two slits 116, 117 is placed on the opposite side of each feedline (to ensure design symmetry). The lengths of the slits can be adjusted to properly cover the desired frequency band of operation.

In one implementation, the slit 115 is on the left side of the patch 114, symmetric with respect to a horizontal line that crosses the midpoint of the patch 114. The slit 116 extends vertically from the bottom of the patch 114 to a position close to the center of the patch 114. The slit 117 extends vertically from the top of the patch 114 to a position close to the center of the patch 114.

Note that FIG. 2 has two different views; the left side of FIG. 2 (as delineated by the dashed line) shows the antenna 102 with its elements layered together (with an added separation between layers to help distinguish them), while the right side of FIG. 2 shows the individual elements laying flat with respect to the z-axis. Note further that the bottom substrate has both its sides shown to show that the feedlines are underneath the bottom substrate; that is, the view 204 is the bottom of the component 104 shown with the negative z-direction coming out of the figure.

FIG. 2 also shows an insulator 222 comprising a layer of air or other spacer (e.g., a sheet of Styrofoam®) that separates the ground plane 112 and the top substrate 220 that supports the patch. Note that electrically speaking, Styrofoam( mimics the properties of air, and therefore its use does not substantially affect the impedance performance or the radiation performance of the antenna.

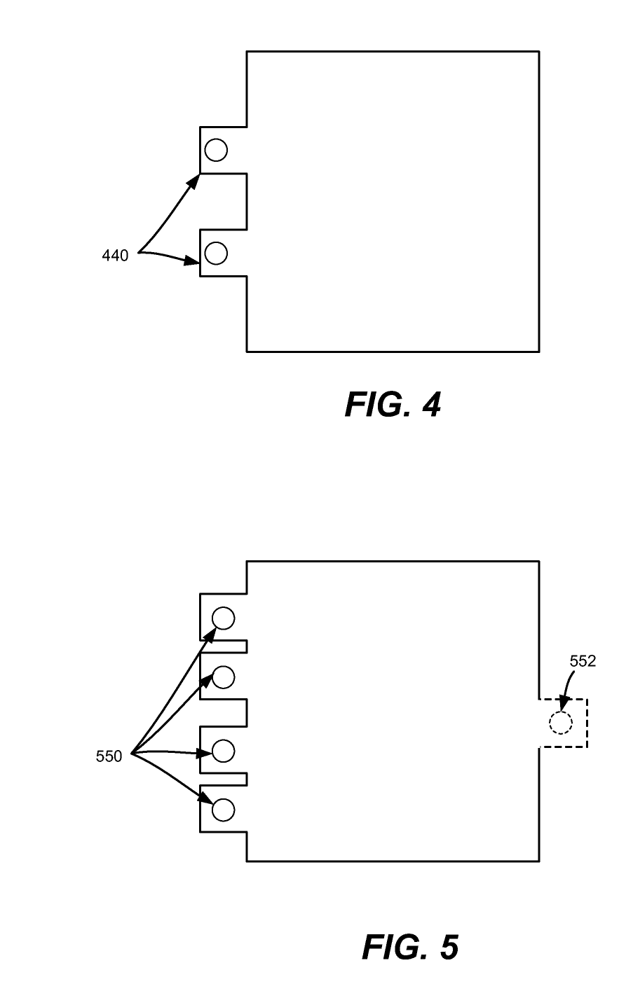

The insulator 222, when formed from a lossless dielectric such as air, can significantly increase the antenna gain when inexpensive and relatively high loss substrates such as FR-4 are used for part of the antenna implementation. If air is the desired insulator 222, the antenna's substrate may be modified in various ways to include locations where plastic spacers or the like may be used to attach the upper substrate 220 to the ground plane 112, e.g., as exemplified in FIGS. 4 and 5 by the patches coupled to tabs and corresponding spacers 440 and 550 respectively, with the circles indicating the areas where spacers can be placed. FIG. 5 also shows an optional (as indicated by the dashed lines) tab and corresponding spacer 552 positioned on the other side of the patch to increase stability, for example; more than one may be used. The tabs may be the same or different material from the patch, and may be coupled to the patch by any means, including by cutting the patch/top substrate so as to include such tabs. Note that if the dielectric constant of such spacers is larger than that of the FR-4 substrate, then any frequency shifts may result; configuring the patch for a desired frequency is described below. Note that spacers can also be used within the boundaries of the patch element, although this may result in performance degradation

Further note that the dielectric layer insulator may be eliminated by selecting appropriate dielectrics for the remaining layers of the antenna structure. The dimensions of the patch/slits are adjustable to account for the dielectric layer structure of the antenna stack; regardless, the three slit design that enhances bandwidth in a dual feedline antenna applies.

An alternative implementation of the antenna may use a multilayer circuit board structure. For example, the layers shown in FIG. 2 may be implemented as a single multilayer board structure. The circuit designer may vary the properties of the dielectric layers including thickness, dielectric constant and loss tangent.

In one implementation, the substrate material for the substrates 220 and 104 is FR-4, which has a dielectric constant (Er) of 4.45±0.25 and a loss tangent (tan δ) of 0.025. The thickness for the substrate 104 between the ground plane 112 and the feedlines 106 and 107 is h₁=39 mils, while the thickness of the substrate 220 between the insulator 222 and the patch 114 is h₂=62 mils. The thickness of the insulator 222 (for an air layer) is hₐᵢᵣ=39 mils. The thickness for the copper (Cu) traces is 1.4 mils, which includes the feedlines 106 and 107, the patch 114 and the ground plane 112. In this implementation, the feedlines 106 and 107 are 71 mils wide in order to provide a 50 ohm input without any discontinuities.

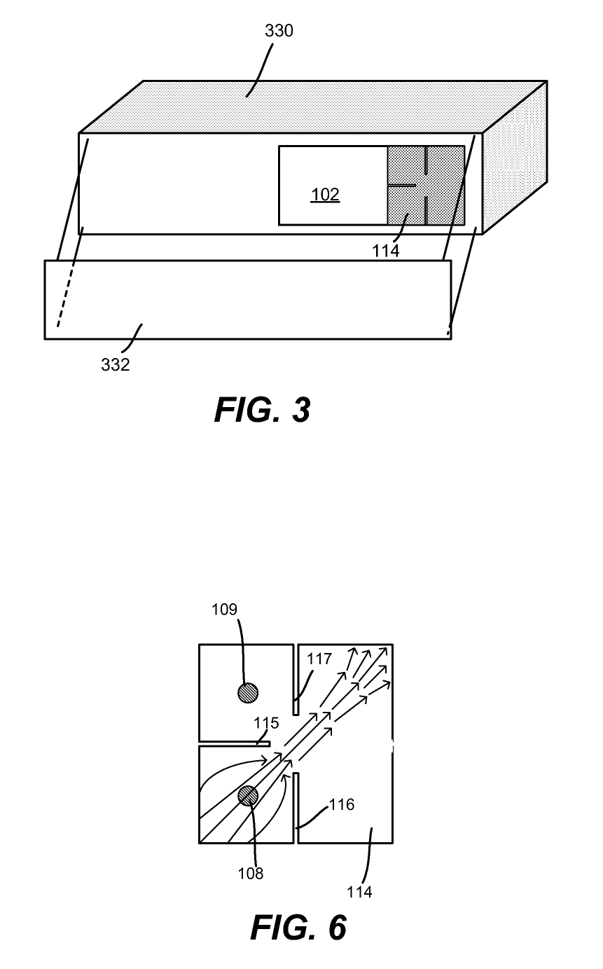

FIG. 3 shows how the antenna 102 may be positioned in a gaming console 330 or the like (with its front cover 332 shown removed for visibility; (note however that FIG. 3 is not intended to show a relative size of the antenna 102 to the console 330, nor of the patch to the overall antenna surface, but rather provides one generalized example of how and where such an antenna may be positioned). In alternative implementations, the antenna may be on the left side of the console, for example; the patch may be flipped over such that the horizontal slit extends in the negative x direction from the edge of the patch, for example, and so forth.

In a gaming console implementation, such an outward facing antenna 330 may provide the communication link between the console and the user's peripheral device (e.g., a controller, joystick, and so forth). One such antenna design operates between 2.4-2.483 GHz, which is the ISM band for Bluetooth® and Wi-Fi connectivity. Notwithstanding, the technology described herein is broadly applicable to patch antennas at any operating frequency range.

The configuration of this antenna makes it straightforward to integrate the antenna 102 to a printed circuit board without the need to modify other circuitry on the board. Note however that the patch 114 and the substrate need not be directly attached to the printed circuit board. In a transmitting (or receiving) mode, the feedlines 106 and 107 allow for two polarizations to be excited individually based on the alignment of the receiving (or transmitting) antenna. The feeding points of the feedlines may be relatively close, e.g., in order to connect the terminals of a switch, a PIN diode or other feed network. The switch, the PIN diode or other feed circuitry serves as the switching mechanism to determine which polarization is excited. Additionally, feedlines 106 and 107 can be excited simultaneously to provide increased signal throughput by way of a larger range of polarizations.

To summarize the operating characteristics of the rectangular patch, having three slits with dual-polarization provides resonant frequency reduction for a given patch size, while bandwidth is increased by reducing or eliminating the fourth slit. The resonant frequency of the antenna is reduced by elongating the surface current paths that define the resonant frequency of operation, as generally shown by the arrows in FIG. 6. Note that the surface currents slightly to the left and right of the patch take a longer path to travel from one corner of the patch to the other corner due to the slits.

More particularly, the position of the slits provides optimal impedance matching. The length of the slits determines the resonant frequency, that is, when the slits are longer, the resonant frequency decreases. However, the decrease in resonant frequency comes at the expense of reduced impedance bandwidth.

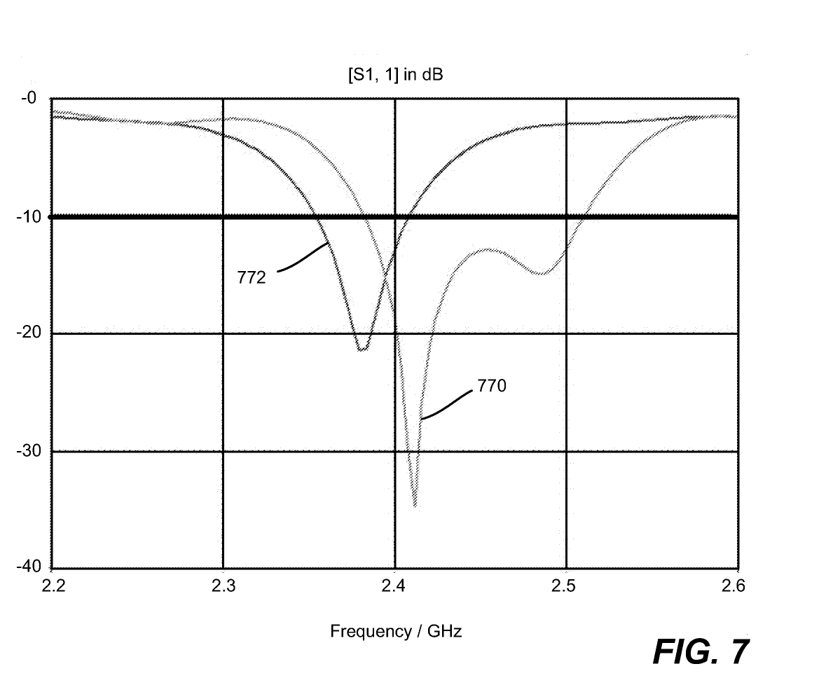

As described herein, eliminating (or substantially reducing the size of) the conventionally-used fourth slit widens the impedance bandwidth that is lost. FIG. 7 shows the return loss versus frequency of the three slit antenna design (the line 770) versus the conventional four slit antenna design (the line 772).

In the return loss, it is seen that the impedance bandwidth is much wider in the design with three slits (the line 770) as opposed to the design with four (the line 772). This is likely due to the existence of a second mode that exists at a higher frequency. This higher mode frequency is close enough to the fundamental mode so the impedance bandwidth of both is combined, leading to a larger overall impedance bandwidth. In this particular implementation, the absolute impedance bandwidth of the three slit design is approximately 2.5 times larger than the design with four slits.

In FIG. 7 it is also seen that the use of the fourth slit has a minimal effect on reducing the resonant frequency. The fundamental mode frequency of the three slit design is higher than that of the four slit design by only a few tens of MHz. This can be corrected as needed by adjusting the length of the slits and/or by adjusting the width of the slits; (both increases have the effect of shifting the frequency band of operation, but adjustments in the width have been found to have a more significant effect). The return loss of the three slit design has a maximum of −12.85 dB, which means that at least 94% of the power input to the antenna is available for radiation. The radiation patterns of the antenna with three slits do not experience any changes due to this modification.

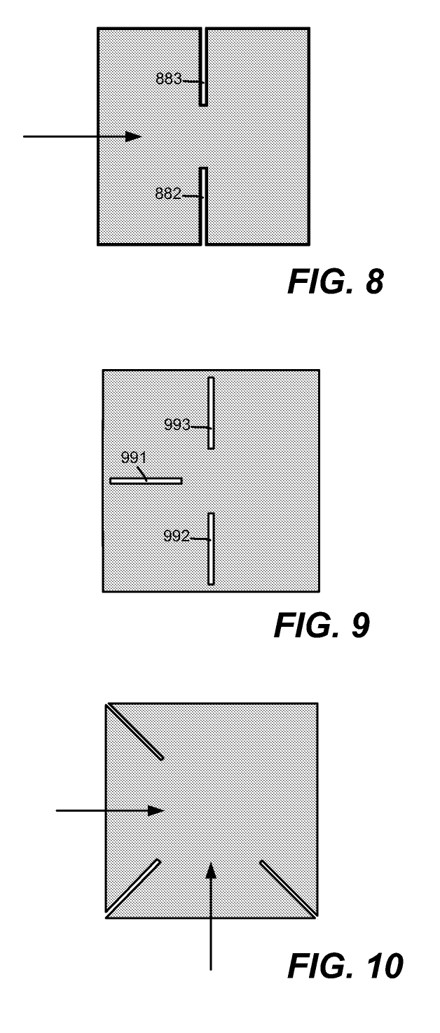

Turning to other variations and alternatives, it should be noted that if only linear polarization is needed, then only two slits are needed to provide the desired frequency and bandwidth results. For example, in FIG. 8, if the feed is in the direction of the arrow, then only two slits 882 and 883 may be present.

As another alternative, FIG. 9 uses slots 991-993 instead of slits to lengthen the currents. In general, both slots and slits are openings (which may be air or filled with any suitable material such as an insulator or higher-resistance material) in the patch, with the difference being that a slit extends to the end of the patch, whereas a slot does not. As used herein, a “slit” and “slot” are equivalent with respect to their being configured to provide desired frequency and/or bandwidth characteristics.

As shown via the feedlines in FIGS. 1 and 2 and the arrows in FIG. 6, in one implementation, the feeding configuration is along the diagonals of the patch. This is done to maintain symmetry with respect to a horizontal line that runs along the middle of the board. Because the antenna is fed along the diagonal of the patch, the longest resonant length occurs from one corner of the patch to the opposite corner, e.g., from the top left corner to the bottom right corner and from the bottom left corner to the top right corner. Notwithstanding, an alternative implementation is shown in FIG. 10, in which the slits are arranged diagonally for handling horizontal or vertical feeds, as represented by the arrows.

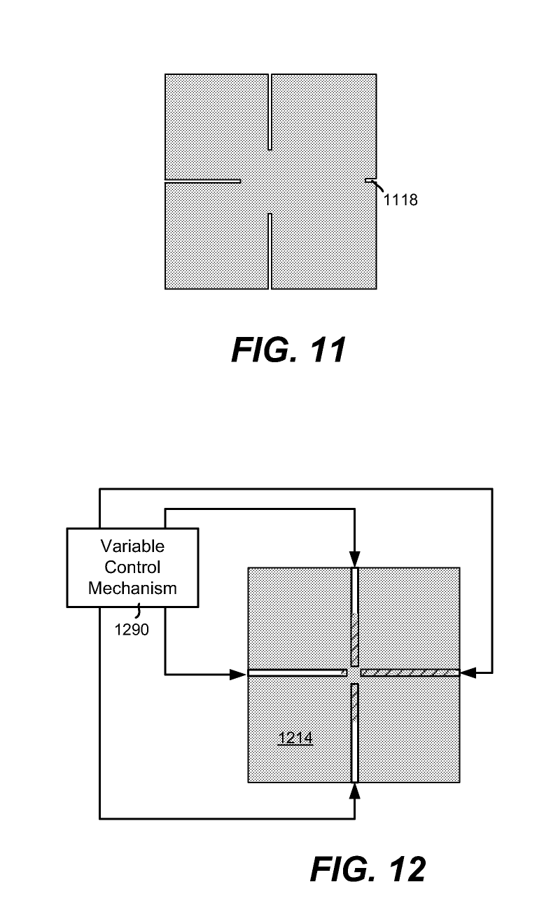

FIG. 11 shows an implementation in which a fourth slit 1118 has not been fully reduced to zero size. While in general an antenna design seeks to provide wide bandwidth, varying the size of the fourth slit may provide benefits in certain applications, such as to act as a sort of frequency filter. Note that such a fourth slit may not extend to the edge of the patch and instead may be a slot.

Turning to another aspect generally represented in FIG. 12, instead of having slits configured by physical location and dimensions, one or more of the slits on a patch 1214 may have variable characteristics with respect to how they affect surface currents, as controlled by a variable control mechanism 1290. Frequency control and/or bandwidth control is one benefit of such a variable antenna.

For example, an electronic device such as a variable resistor, a set of control diodes, and so forth may be controlled with control currents to alter the surface currents of a patch 1214, as if a slit (or slot) was present with effectively variable dimensions. A mechanical device may likewise be used as the variable control mechanism 1290, e.g., to change the physical properties of the surface and thus the surface currents. Such a variable control mechanism 1290 may be dynamic (e.g., processor-based) or static (e.g., manually tuned once). Further, as depicted by the shading within the slits in FIG. 12, the variable slits need not be controlled evenly, but may be independently controlled.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. A system comprising, a patch antenna, including a patch coupled to at least one feedline, the patch having two or more frequency slits configured to meet specified frequency characteristics, and, if present, a bandwidth slit that is configured to meet bandwidth requirements.

2. The system of claim 1 wherein the frequency slits are configured by their dimensions to meet the specified frequency characteristics.

3. The system of claim 1 wherein the antenna comprises a dual-polarized antenna with two feedlines, and wherein the patch includes three frequency slits arranged symmetrically with respect to the feedlines.

4. The system of claim 1 wherein the patch is substantially rectangular in x and y directions, wherein two feedlines are present that are substantially diagonal with respect to the x and y directions, and wherein the patch includes three frequency slits, including a first of three frequency slits that extends substantially horizontally in the x or negative x direction with respect to the patch, a second of the three frequency slits that extends substantially in the y direction with respect to the patch, and a third of the frequency slits that extends substantially in the negative y direction with respect to the patch.

5. The system of claim 1 further comprising a ground plane, and wherein the patch is separated from the ground plane by an insulator.

6. The system of claim 5 wherein the insulator is air, and further comprising spacers that couple the patch to the ground plane, the spacers positioned on tabs coupled to the patch.

7. The system of claim 1 wherein the patch is coupled to each feedline by aperture coupling via a slot in a ground plane corresponding to each feedline.

8. The system of claim 1 further comprising a substrate, a top surface of the substrate including a ground plane, and each feedline being on a bottom surface of the substrate.

9. The system of claim 1 wherein the frequency slits are configured by a variable control mechanism.

10. The system of claim 1 further comprising a gaming console that uses the antenna to communicate with a peripheral device.

11. An antenna comprising:
a lower substrate that supports a ground plane on a top surface of the lower substrate, and one or more feedlines on a bottom surface of the lower substrate; and
an upper surface that supports a radiating patch, the upper surface coupled to receive energy at the radiating patch from a feedline of the lower substrate, the radiating patch having at least two frequency slits that determine a resonant frequency of operation of the antenna based upon dimensions of the frequency slits, and the patch having no bandwidth slit or a substantially reduced bandwidth slit so as to meet a specified bandwidth requirement.

12. The antenna of claim 11 wherein the antenna comprises a dual-polarized antenna with two feedlines, and wherein the patch includes three frequency slits arranged symmetrically with respect to the two feedlines.

13. The antenna of claim 12 wherein one selected feedline at a time feeds energy to the patch, and wherein the patch receives energy from the selected feedline through a slot in the ground plane.

14. The antenna of claim 11 wherein the patch is substantially rectangular in x and y directions, wherein two feedlines are present that are substantially diagonal with respect to the x and y directions, and wherein the patch includes three frequency slits, including a first of three frequency slits that extends substantially horizontally in the x or negative x direction with respect to the patch, a second of the three frequency slits that extends substantially in the y direction with respect to the patch, and a third of the frequency slits that extends substantially in the negative y direction with respect to the patch.

15. The antenna of claim 11 wherein the patch is separated from the ground plane by an insulator.

16. The antenna of claim 15 wherein the insulator is air, and further comprising spacers that couple the top substrate and supported patch to the ground plane, the spacers positioned on tabs that support the top substrate and supported patch.

17. A system comprising, a dual-fed patch antenna that is substantially rectangular in x and y directions, a patch, two feedlines that feed energy to the patch, the feedlines being substantially diagonal with respect to the x and y directions, and the patch including three frequency slits, including a first of three frequency slits that extends substantially horizontally in the x or negative x direction with respect to the patch, a second of the three frequency slits that extends substantially in the y direction with respect to the patch, and a third of the frequency slits that extends substantially in the negative y direction with respect to the patch, the patch having no bandwidth slit or a substantially reduced-size bandwidth slit.

18. The system of claim 17 wherein the patch receives energy from the feedlines by aperture coupling.

19. The system of claim 17 wherein the patch is separated from a substrate that supports the feedlines by an insulator.

20. The system of claim 17 wherein the antenna is coupled to a first device that uses the antenna to communicate with a second device.
